(19) United States
(12) Patent Application Publication
(10) Pub. No.: US 2002/0156671 A1
(43) Pub. Date: Oct. 24, 2002

(54) System and method for collaborative action

(75) Inventors: Douglas F. Libra, Lake Stevens, WA (US); Gerald C. Lee, Woodinville, WA (US)

Correspondence Address: Lawrence W. Nelson, The Boeing Company, P.O. Box 3707, M/S 13-08, Seattle, WA, 98124-2207, US

(73) Assignee: The Boeing Company

(21) Appl. No.: 10/008,234

(22) Filed: Nov. 7, 2001

Related U.S. Application Data
(60) Provisional application No. 60/246,930, filed on Nov. 8, 2000.

(51) Int. Cl. G06F 17/60

(52) U.S. Cl. 705/9

(57) ABSTRACT

In one aspect, the present invention relates to a method of reducing the overall time required for more than one party to collaboratively perform a number of tasks, where each task requires a series of collaborative actions, said method comprising the steps of recording the series of collaborative actions into a script of database; and displaying a status of the actions taken in each of the tasks, wherein the status of each task may be simultaneously viewed, and wherein each party may view the status of each task.

### FIELD OF THE INVENTION

The present invention relates to a system and method for collaboration, and more particularly, to a system and method to allow two or more parties to efficiently collaborate on one or more projects.

### BACKGROUND OF THE INVENTION

Traditionally, parties separated by distance have collaborated via long telephone conferences or random exchanges of E-mail. Through these communications, work issues are addressed and actions were assigned haphazardly and inefficiently. In many cases one party fails to take action because they erroneously believe they are waiting for another party to complete an action. The sharing of data with many individuals in paper format, like action items, evaluations, charts, etc., allows information to be easily lost.

Information about the project is typically retained by many independent systems incapable of intercommunication. This forces each party to update information received from another party, imparting an inherent inefficiency. Unfortunately, traditional methods of collaboration are paper intensive, time and labor intensive, and inherently inefficient. Accordingly, there is a need in the art for a more efficient method of inter party collaboration.

### BRIEF SUMMARY OF THE INVENTION

In one aspect, the present invention relates to a method of reducing the overall time required for more than one party to collaboratively perform a number of tasks, where each task requires a series of collaborative actions, said method comprising the steps of recording the series of collaborative actions into a script of database; and displaying a status of the actions taken in each of the tasks, wherein the status of each task may be simultaneously viewed, and wherein each party may view the status of each task.

### BRIEF DESCRIPTION OF THE OF THE DRAWINGS

These and other features and advantages of the invention will now be described with reference to drawings of certain preferred embodiments, which are intended to illustrate and not to limit the present invention:

FIG. 1 is a high-level drawing illustrating the primary components of a collaborative system of a first embodiment of the present invention;

FIG. 2 illustrates a display of the collaborative system according to the first embodiment of the present system;

FIG. 3 illustrates a sequence of steps that are performed by the collaborative system according to the first embodiment of the present invention;

FIG. 4 illustrates a display of a collaborative system according to a second embodiment of the present invention;

FIG. 5 illustrates a sequence of steps performed for reporting and updating the collaborative system according to the second embodiment of the present invention;

FIG. 6 is a high-level architectural drawing illustrating the primary components of a collaborative system of a third embodiment of the present invention;

FIG. 7 illustrates a sequence of steps in a main application performed by a processor to allow inter party corroboration according to the third embodiment of the present invention;

FIG. 8 is a screen display of a task list according to the third embodiment of the present invention;

FIG. 9 illustrates a sequence of steps performed by a subroutine of the main application to develop a task script;

FIG. 10 is a screen display of a task script input screen;

FIG. 11 is a screen display of a task script input screen for inputting actions;

FIG. 12 is a screen display of a task script editing screen;

FIG. 13 is a screen display of a task script according to the third embodiment of the present invention;

FIG. 14 illustrates a sequence of steps performed by a subroutine of the main application to update a status report;

FIG. 15 is a screen display of a task status report;

FIG. 16 illustrates a sequence of steps performed by a subroutine of the main application to notify parties of new issues;

FIG. 17 is a screen display of a new issue input screen;

FIG. 18 is a screen display of an issue report screen;

FIG. 19 is a screen display of a task schedule;

FIG. 20 is a high-level architectural drawing illustrating the primary and optional components for implementing a corroborative testing web site according to a fourth embodiment of the present invention;

FIG. 21 is a flow diagram illustrating information received and provided by a user of the test web site;

FIG. 22 is a screen display personalized for a user of the Test Web Site;

FIG. 23 is a flow diagram illustrating the interaction of the user and a test script of one for the embodiment of the present invention;

FIG. 24 is a flow diagram illustrating the interaction of the user test status report of the present invention;

FIG. 25 is a screen display of a test status report of the fourth embodiment of the present invention;

FIG. 26 is a screen display for inputting test results;

FIG. 27 is a flow diagram illustrating the interaction of the user and the test web site when addressing process issues;

### DETAILED DESCRIPTION OF THE INVENTION

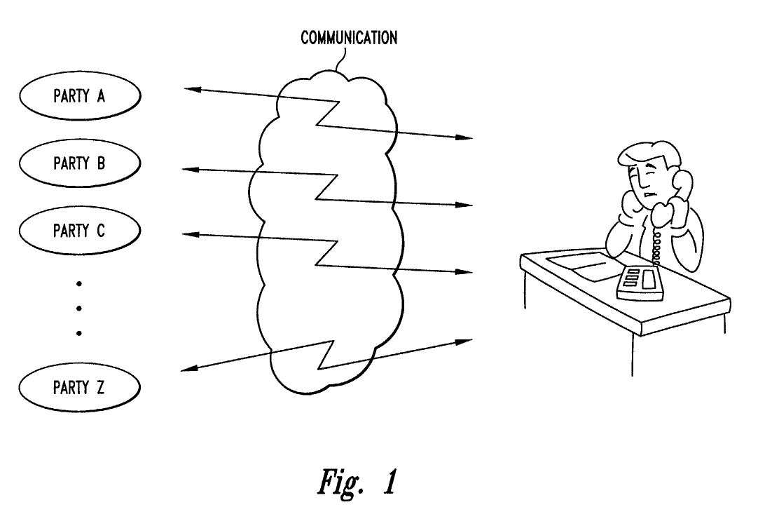

FIG. 1 illustrates the most general structure of a collaborative system 5 that operates in accordance with the present invention. The system includes multiple parties 10, a focal 12, a communication system 14, and a display 16. The multiple parties 10 and focal 12 may be individuals, devices, institutions, or other organized entities. The communication system may be interpersonal, physical, or electronic in nature.

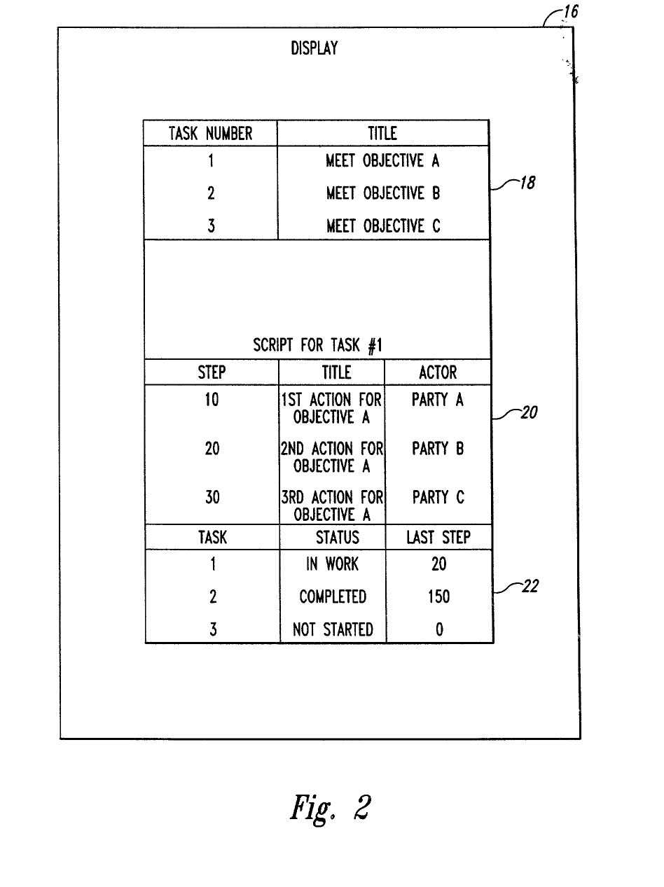

The physical or electronic display 16, as shown in FIG. 2, includes a task form 18, an exemplary script 20 for a first task, and a status table 22. Each portion of the display is preferably viewable on demand. The collaborative system 5 increases the speed and visibility of collaborative tasks by having the focal 12 post and constantly update the status of each task at the display 16. By increasing speed and visibility, working relationships between the parties are enhanced and task costs are reduced.

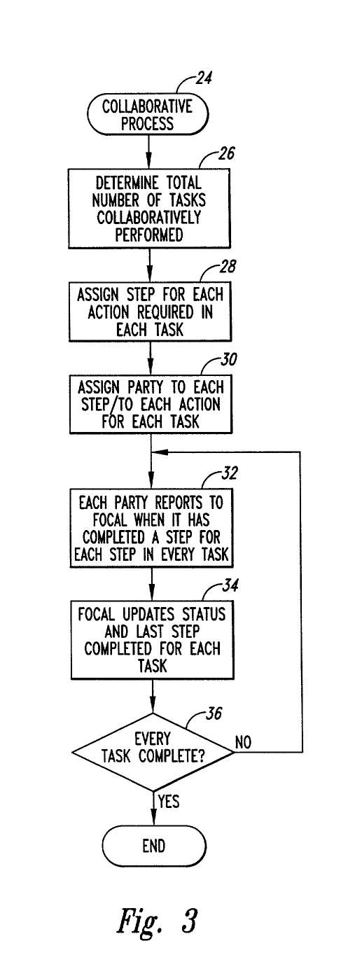

FIG. 3 illustrates the steps of a process 24 implemented by the system 5 of the present invention. Initially, in step 26, a total number of tasks to be collaboratively performed by the collaborating parties, are recorded on the task table 18. Next, in step 28, each step for each action required to perform one of the tasks is recorded in a script, such as the script 20, where each task is assigned its own script. In each script 20, for each of the tasks, a party is assigned one or more steps to perform within the script 20, in step 30. Next, in step 32, each party 10 reports to the focal 12 when it has completed a step in one of the scripts 20. This updating step is performed for each task. In step 34, the focal 12 updates the status table 22 to indicate the last action completed for each task, and whether the task has been started, is in work, or has been completed. Finally, the focal 12 in step 36 ends the updates when all tasks have been completed.

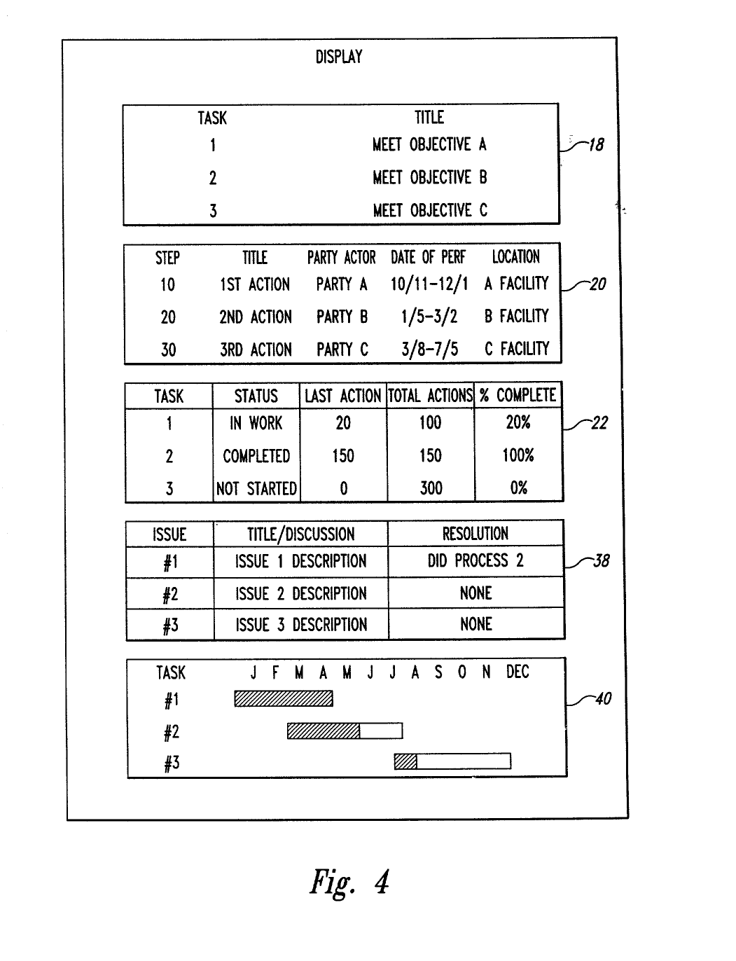

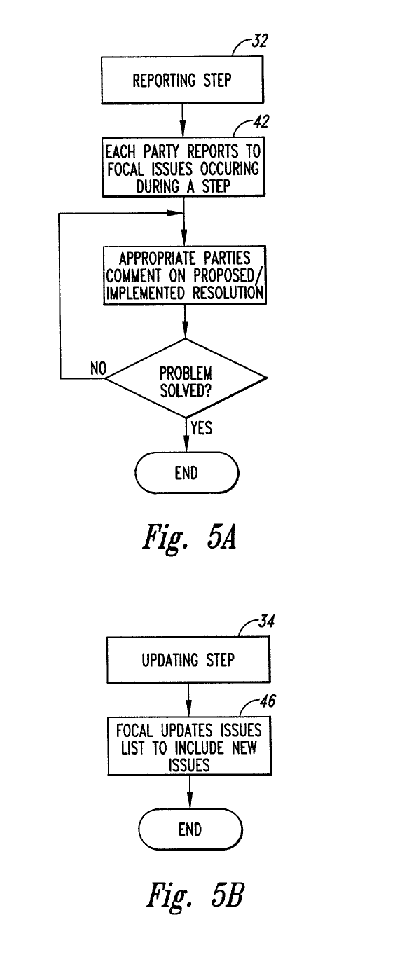

In a second embodiment, the system 5 enhances the display 16 to include a list of process issues 38, and a test schedule 40, as shown in FIG. 4. The list of process issues 38 includes issues such as problems, shortages, etc., which may be interfering with the completion of an action for a particular task. The issues are posted so that each party, including the focal 12, has the opportunity to evaluate the issue and propose a resolution. A sequence of reporting steps for reporting issues, as shown in FIG. 5A, includes step 42 of each party 10 reporting to the focal 12 any issues that occur during a step in one of the scripts 20. An appropriate member of the parties 10 comments on a proposed or implemented resolution to the issue in step 44. Step 44 is repeated until the issue is resolved. The reporting step, as shown in FIG. 5B, includes a step 36 of the focal 12 updating the issues list to include new issues.

As shown in FIG. 4, the display 16 preferably includes the steps or actions for each task. Here an exemplary script 20 for the first task includes a series of sequential steps associated for each sequential action to be performed in the task, an assignment of an individual, group, machine, or combination thereof of one of the parties 10 to perform each of the actions, an assigned date each action is scheduled to be performed, and the location where the action will take place.

The status form 22 of the display 16, as shown in FIG. 4, preferably includes indicating two or more tasks and whether a part of one of the tasks has not been started, is in work, failed, or has been completed. The status form 22 also includes the last action completed, the total number of actions in each of the tasks, and the percentage of number of actions completed for each of the tasks.

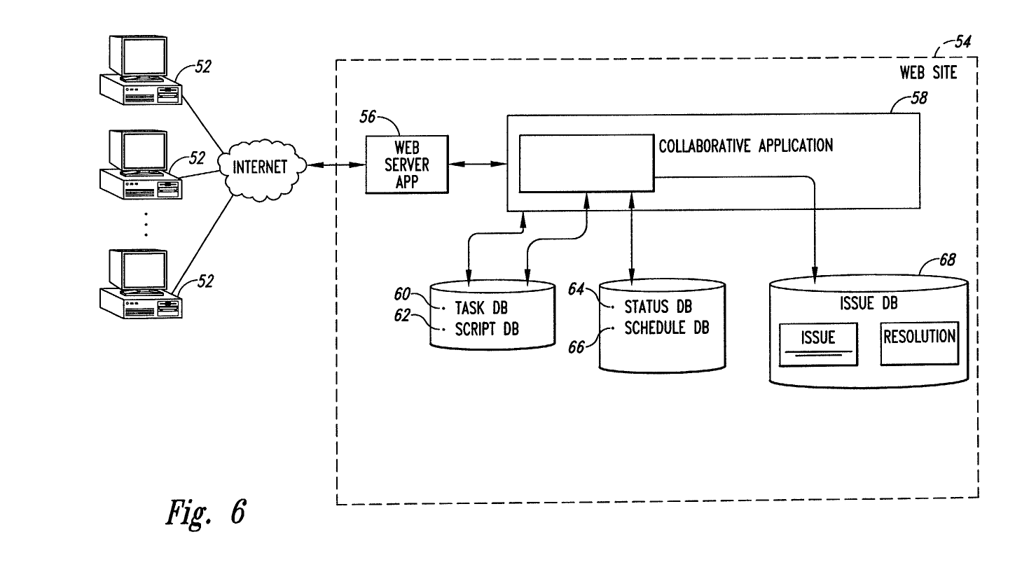

FIG. 6 illustrates the general architecture of a third embodiment of a collaborative computer system 50 according to the present invention. The computing system 50 includes a computer 52 operated by each of the collaborating parties, a collaborative web site 54, having a web server application 56 for communicating with each party's computer 52 over the Internet, and a collaborative application 58 which provides access to the site's various databases, each application being run by a CPU (not shown). The databases include a task database 60, including the title of each task to be performed by the parties, and a script database 62, which includes all the actions required to perform each one of the tasks. The databases also include a status database 64, which includes the status of each task and the last action completed, and a schedule database 66, including the scheduled time allotted for each task and the percent of the task completed. The databases further include an issue database 68 which includes the issues encountered by the parties, as well as potential or implemented resolutions. The aforementioned databases may be a plurality of tables within a single database.

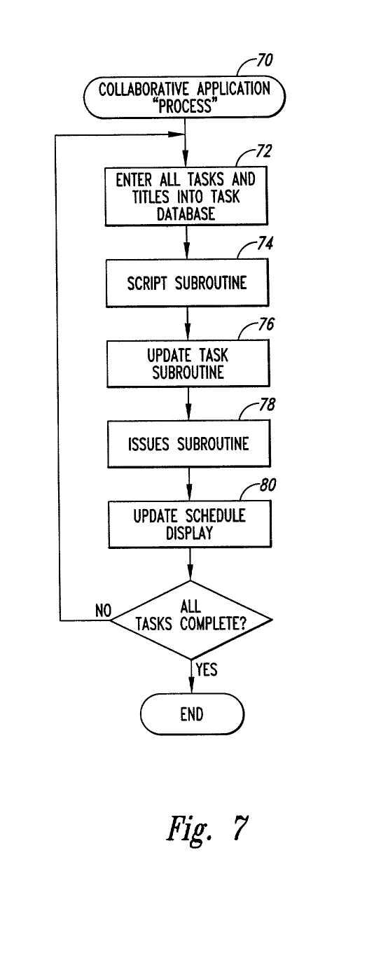

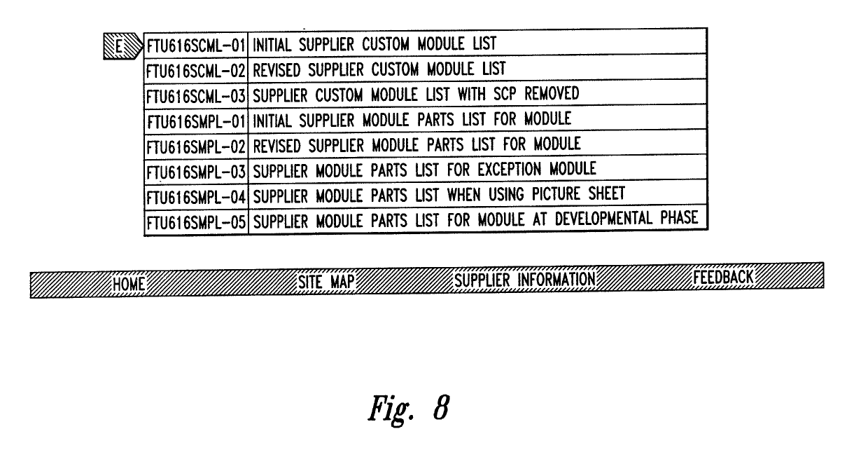

FIG. 7 shows a main application and process 70 implemented by the collaborative application 58 of the web site 54. Initially, a processor in implementing the application 58, in step 72, requires entry of all tasks, identified by a script number, and an associated title into the task database 60. Each user via their computer 52 may view the task database 60 at the corroborative web site 54 in a format as shown in FIG. 8.

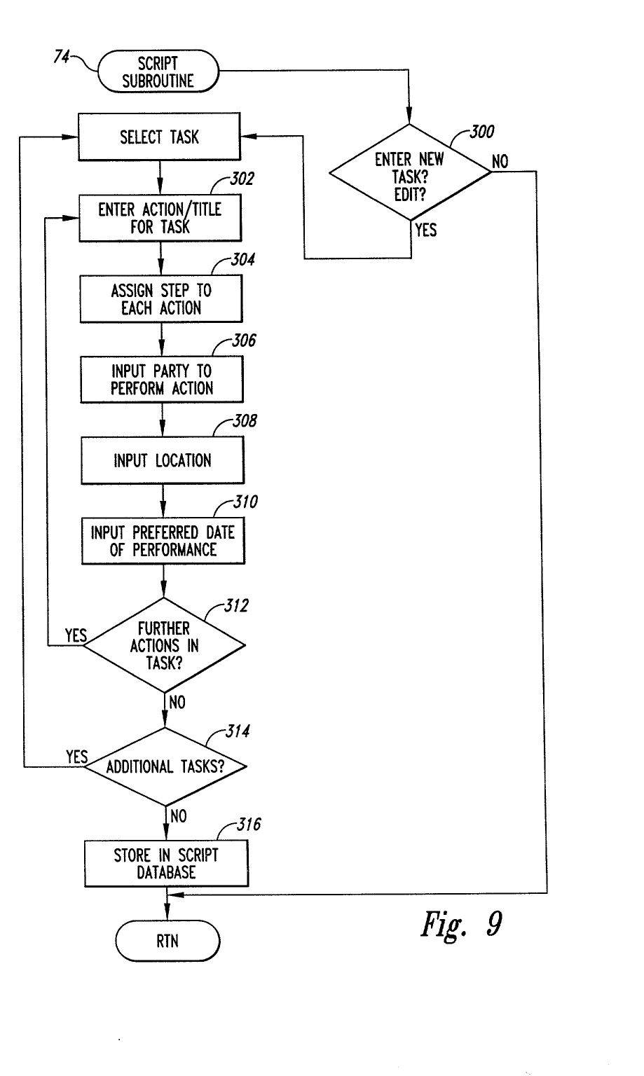

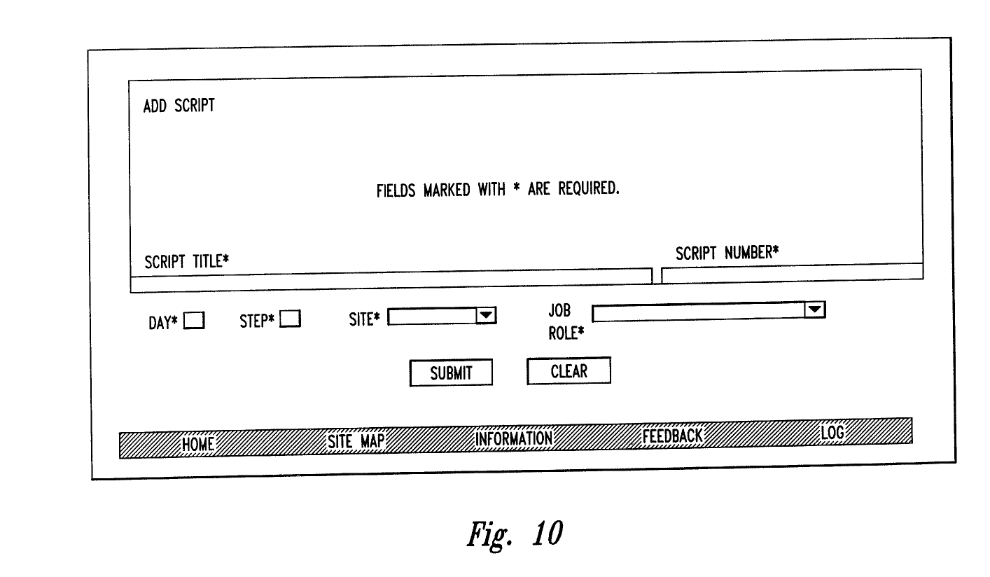

In step 74, the application 58 invokes a script subroutine, as shown in FIG. 9. The script subroutine enters new scripts and edits prior scripts on the script database 62; if no script is added or edited, then step 300 returns to the main application 70. However, if a new script has been added, then the application 58 proceeds to step 301 and selects a task. A party user adding a test script will be provided a form by the web site 54 as shown in FIG. 10. Each new task has a script title and script number, added in step 302, as well as a schedule for performance. In step 304, the application 58 assigns each action a sequential step.

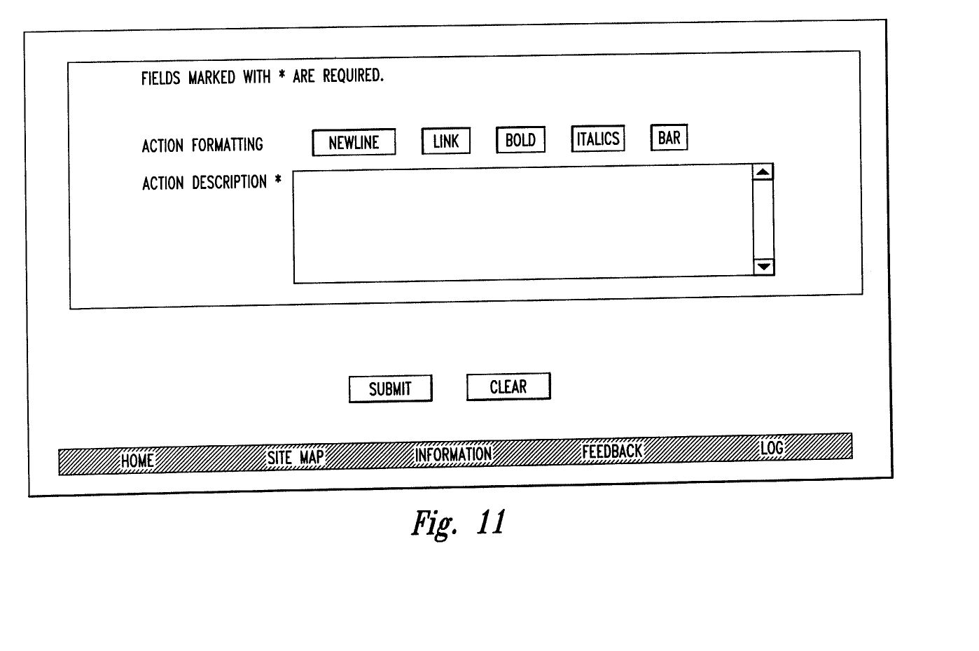

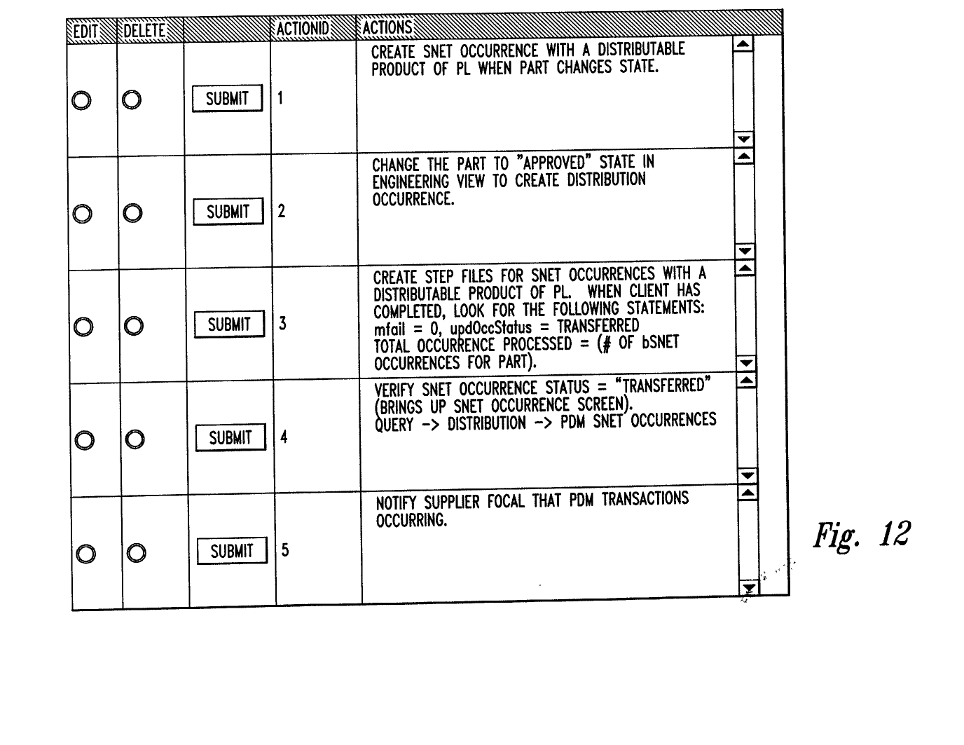

The web site 54 provides a form for inputting a detailed action description, as shown in FIG. 11. In step 306-310, the application 58 inputs an action and associates a party to perform the action, a location of performance and preferred date of performance. The application 58, in step 312, ensures all actions/steps have been entered, and step 314 checks for additional new or edited tasks. A user party is provided a form, shown in FIG. 12, to assist in editing a script action. In step 316 the application stores all inputted script data to the script database 62.

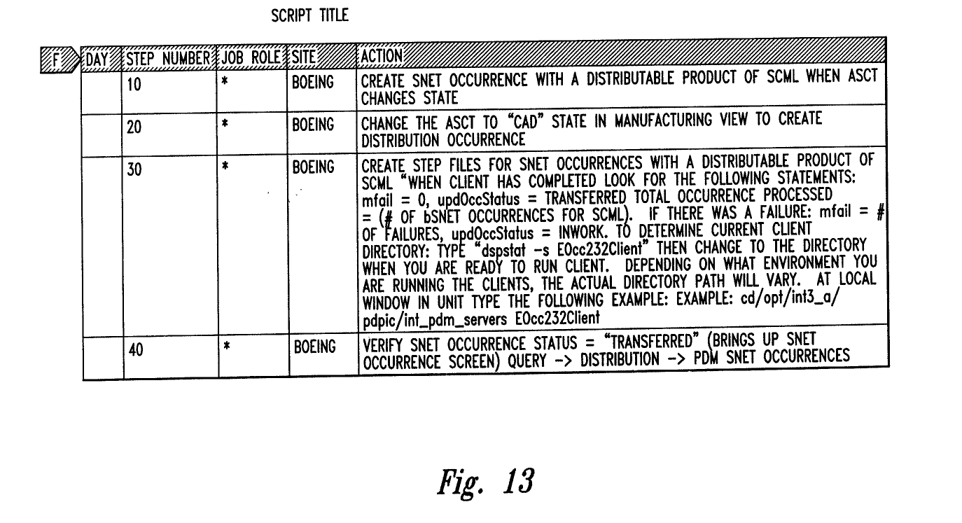

A party via their computer 52 may recall a script of a particular task from the script database 62. Preferably, the script will be displayed as shown in FIG. 13. Here, the range of days for steps to be completed is shown in the “day” field; each step number is displayed and associated with an action. The “job role” field indicates which collaborating party will be performing the action, and the “site” field is the proposed location the action is to occur.

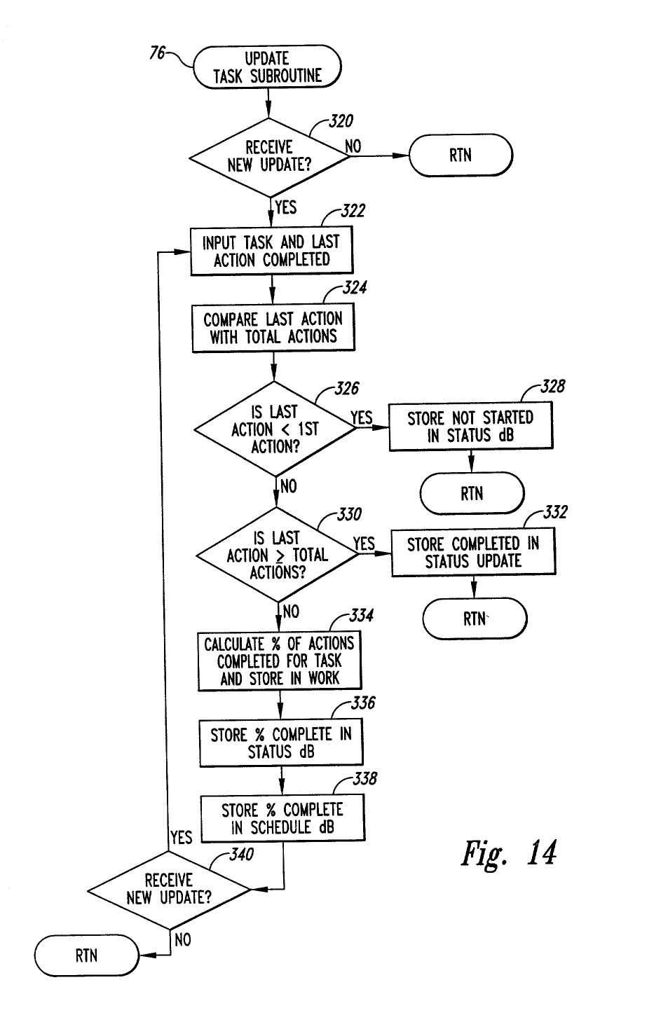

When all scripts have been added or edited, the application 58 invokes the update task subroutine 78, as shown in FIG. 14. In step 320, the application 58 checks for new updates on actions. If none have occurred, then it returns to the main application 70. If an update has been received, then the application 58 proceeds to step 322, inputting the last action attempted, whether it was successful or failed, the last action completed, and the associated task prompting for the task's script number. In steps 324-334, the application 58 compares the last action completed with the total number of actions in the task. If no action has been taken, then a “not started” status is stored in the status database 64. If the last action completed has the final action of the task, then a “complete” is stored in the status database. If neither occurred, then the application will store an “in work” in the status database, as well as calculate and store the percentage of actions completed, in the task. The percentage complete is then updated in the schedule database 66. The application 58 continues to enter new updates until all updates have been stored in the status database 64.

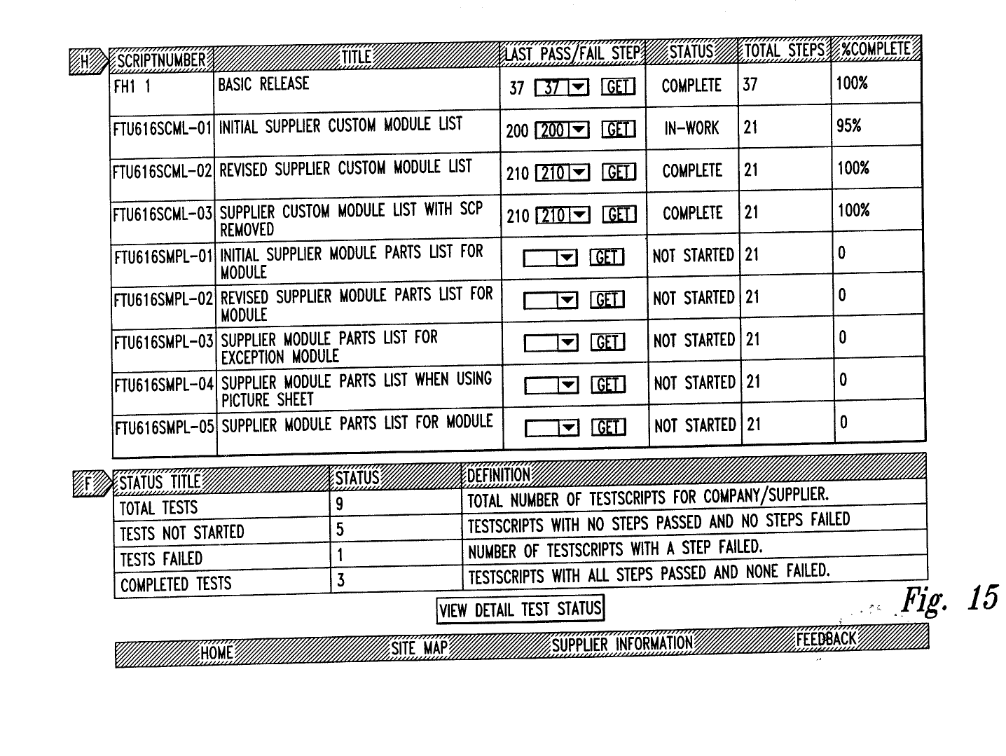

A party user may instantly view the status of each task on the web site 54. Preferably, the party user will be provided status screen information in the format shown in FIG. 15. A script number identifies each task being collaborated on by the parties; the title also identifies the task. The “Last Pass/Failstep” field indicates the last action attempted in the task and whether it was successfully completed (i.e., pass) or not completed successfully (i.e., fail). A hyperlink on the “get” button will allow the party user to see if the last step failed. The “get” button goes to the screen where the user can enter/edit test results. The “status field” indicates at a glance whether the script was completed, not started, failed, or in work. The total number of steps/actions and the percentage of steps/actions completed are also displayed on field. Use of the status screen provided by the web site 54 allows multiple partners to immediately see which tasks need to be completed, and whether they may begin the next action in a task after the previous action/step has been successfully completed by another party, including an individual, an organization, or device. This significantly increases the speed and efficiency of any collaborative action.

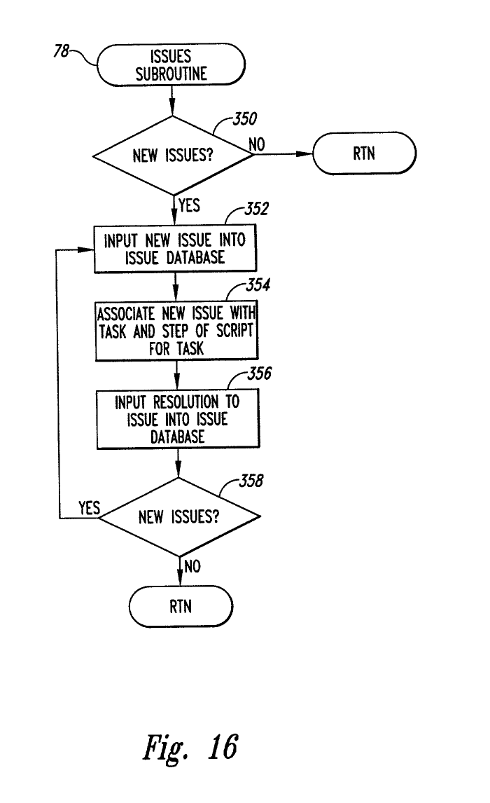

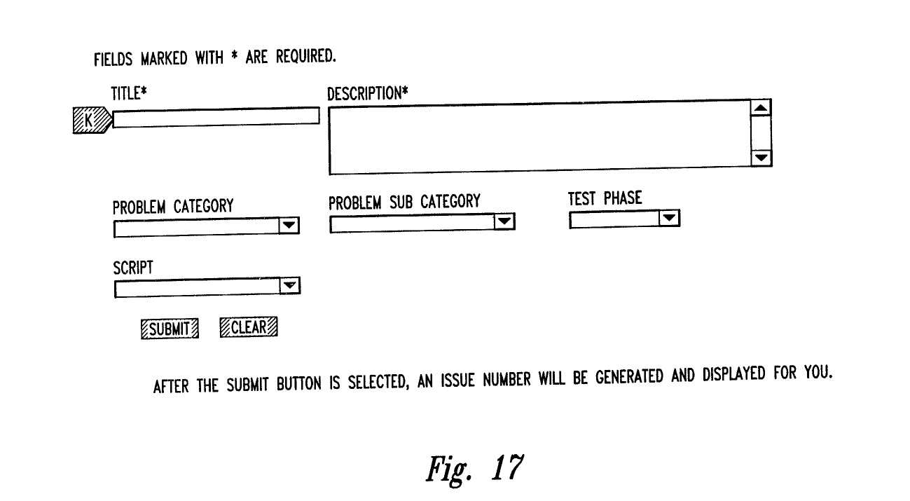

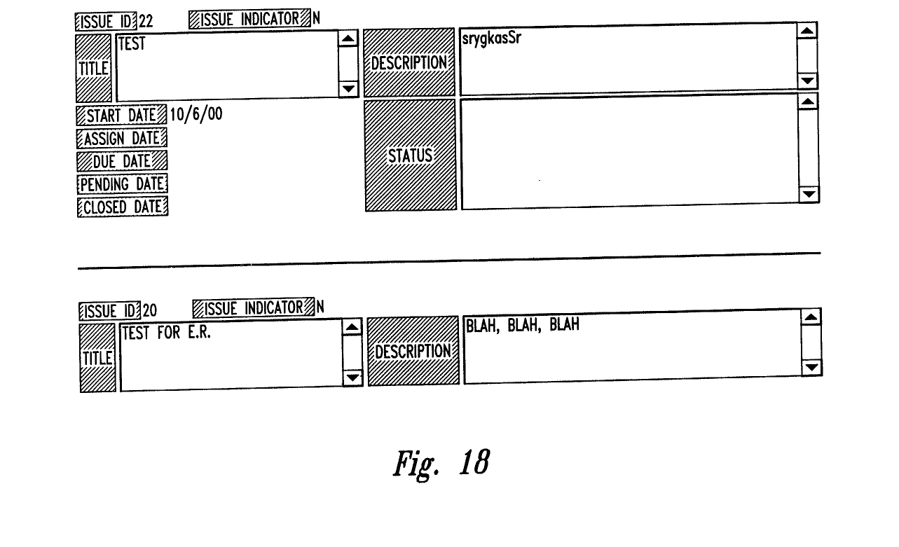

Once the application 58 has updated the status database 64, it invokes the issues subroutine 78, as shown in FIG. 16. The application 58, in step 350, checks for open issues; if there are none, it returns to the new application 70. The web site 54 provides a form, shown in FIG. 17, for submitting new issues. The new issues are typically related to problems encountered during the performance of an action/step in a particular task. In step 352, the new issue is stored in the issue database 64. In step 354, the application 58 associates the issue with a step of a script for a particular task; and in step 356, the application preferably awaits and inputs a suggested or implemented resolution to the issue. The web site 54 provides an informational screen, shown in FIG. 18, indicating the status and description of all issues encountered during the collaboration effort of the parties. Once all new issues have been input, the issues subroutine 78 returns to the main application 70.

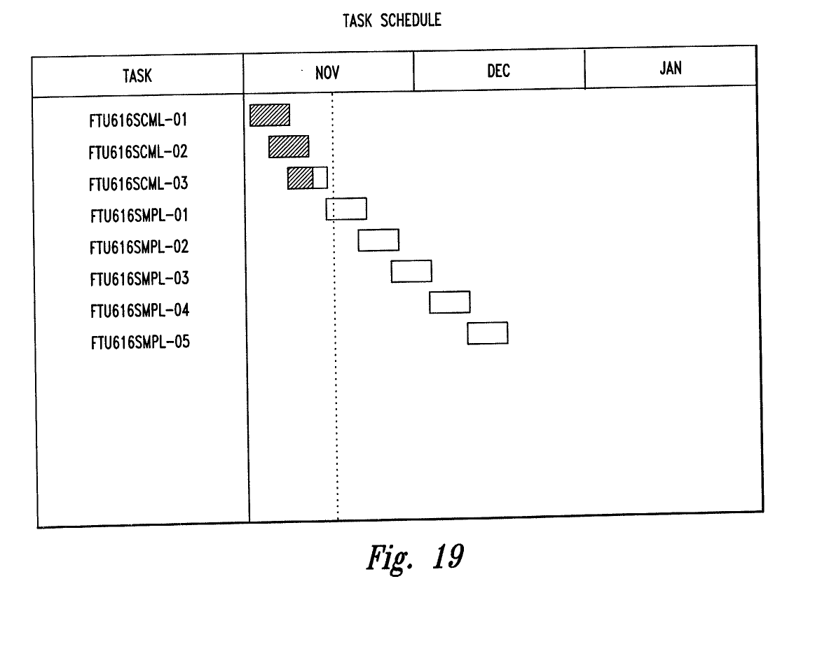

The application 58 proceeding to step 80 updates the schedule. As shown in FIG. 19, the schedule includes a task description, and the proposed dates the task will be “in work” as denoted by a bar graph. Each bar of the bar graph is shaded by being manually updated or preferably by being dynamically updated by the status database to indicate the percentage of actions completed as the percentage of the bar shaded. When all collaborative tasks have been successfully completed or abandoned, the application 70 ends.

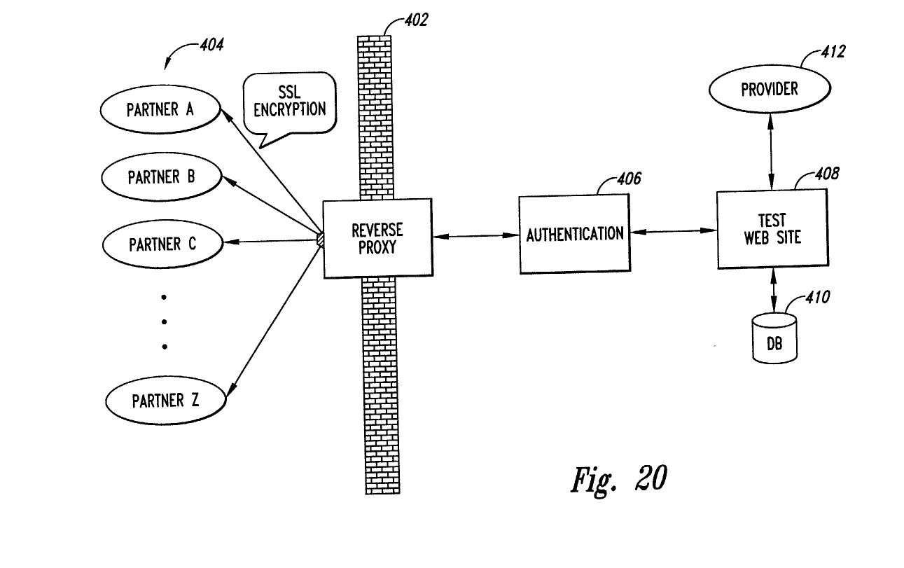

FIG. 20 illustrates the general architecture of a fourth embodiment of a collaborative computer system 400 between a service provider and a partner. The service being provided by the service provider includes one of information, general services, communication, or interaction of computing systems. In this embodiment, the computer system 400 assists in a collaborative testing of the connectivity, interaction, and ability to retrieve information between computing systems.

The testing computer system 400 includes a firewall 402, which uses a reverse proxy. The system 400 only communicates with a desirable party 404 via SSL encryption. The partner is authenticated via an Authentication Database 406 and then permitted access to a Test Web Site 408 using a database 410, which is accessible to a provider user 412.

The Test Web Site 408 allows a user to select a test script, test status, to submit an issue, view all issues, view proposed issues, view open issues, view pending issues, view closed issues, test schedule, telecon schedule, and contacts.

The provider may be involved in numerous collaborative testing efforts, and the Test Web Site 408 allows the provider user 412 to select a particular company as the current partner. The list of partners is in a drop-down box shown in Table 1.

TABLE 1
List of Partners
DAISST

| List of Partners | Partner Code |
|---|---|
| A | 01 |
| B | 02 |
| C | 03 |
| D | 04 |
| E | 05 |
| F | 06 |
| G | 07 |
| H | 08 |

Users that access and use the Test Web Site 408 preferably have a browser that supports cookies, and the browser should be configured to accept cookies. The Test Web Site 408 is structured so one partner will not have the ability to view other partner's data (i.e. test scripts, test status, issues, etc.). Any data that is partner unique, and not located in the database 410, shall be stored in a separate directory on the Test Web Site 408.

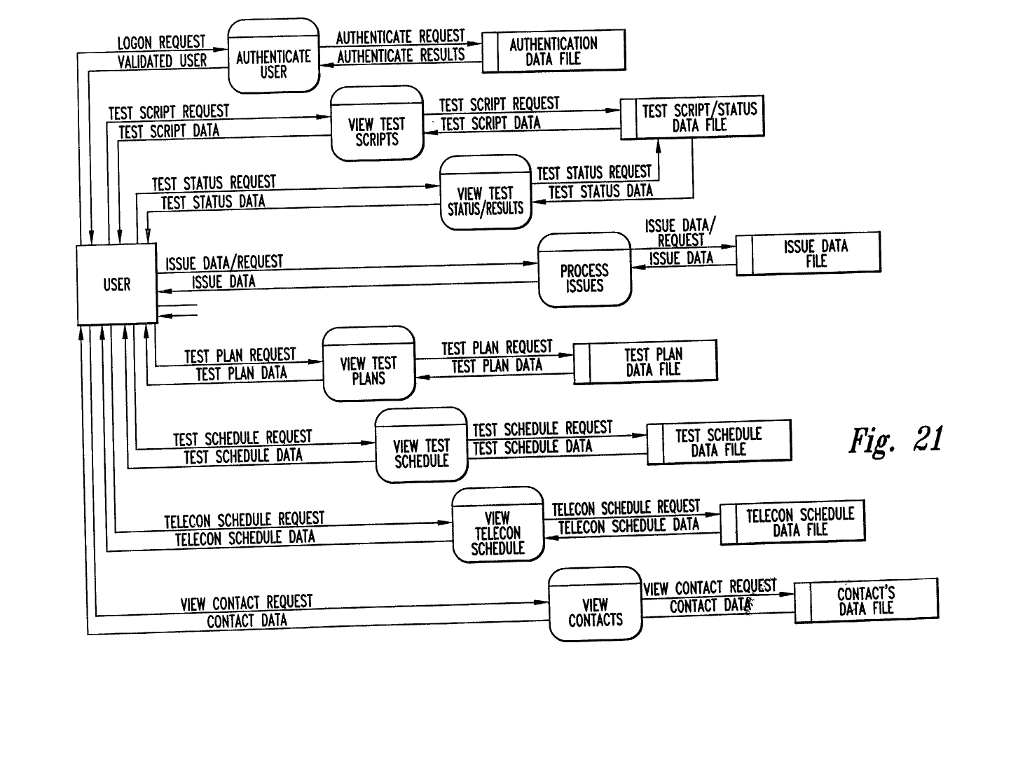

The partner user is preferably authenticated, via a user ID and password, as depicted in the system flow diagram shown in FIG. 21.

The Test Web Site 408 shall check the user ID. If the user ID is in the Authentication Database 406, then the user shall be allowed to gain access to the Test Web Site. If the user ID is not in the Authentication Database 406, then the user shall not be allowed to gain access to the Test Web Site 408.

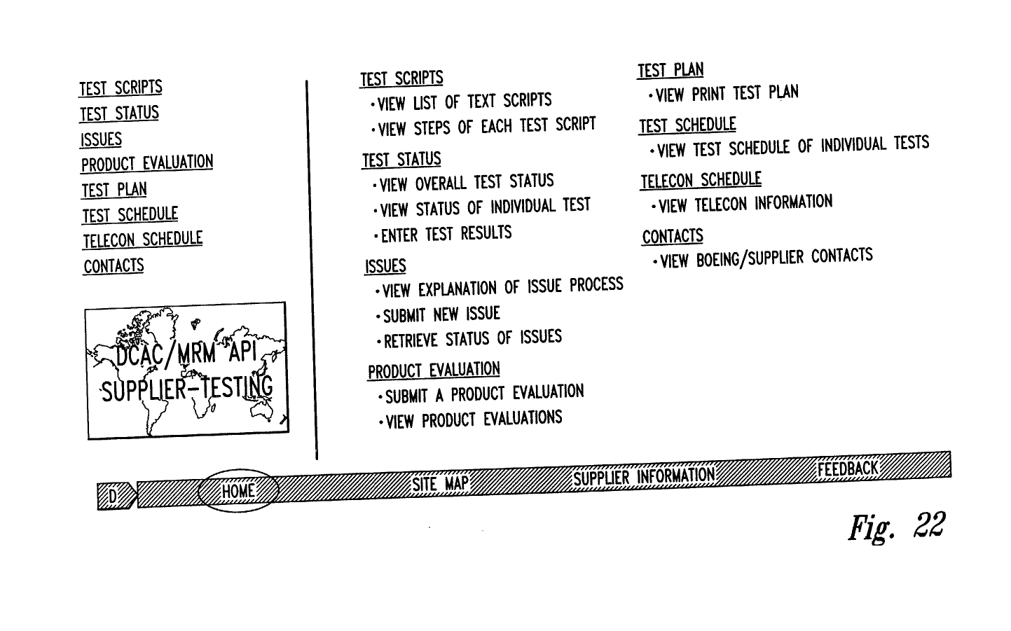

The Test Web Site 408 shall check the ID. If the proper ID is received by the Authentication Database 406, then the user shall be allowed to gain access to the Test Web Site 408 and a personalized Test Web Site's Home Page shall be displayed, as shown in FIG. 22. If the ID is not in the Authentication Database 406, then the user shall not be allowed to gain access to the Test Web Site 408, and a message indicating that the incorrect user ID and/or password was entered shall be displayed to the user.

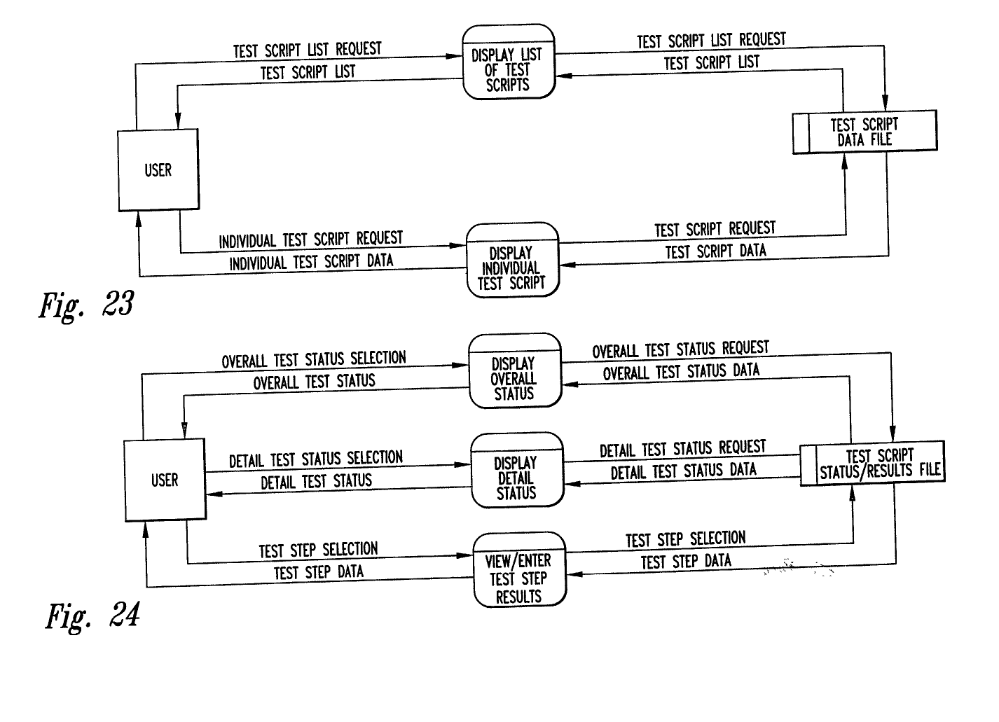

In this embodiment, as shown in FIG. 23, the Test Web Site 408 displays the script number and title of each test script associated with a unique partner. The Test Web Site 408 provides the capability to view each test step within each test script, where each test step includes: Day; Step Number; Job Role; Site (Provider or Partner); and Action. The Day column displays the anticipated day in which this test step is to be executed, the Step Number column displays the test step number, and the Job Role column displays either the Provider or Partner.

The Site column displays the location of the action of either Provider or Partner, depending on if this step is a Provider action or a Partner action. The Action column displays the contents of the specific action that the step requires.

In this embodiment, as shown in FIG. 24, the Test Web Site 408 provides the capability to view overall test status. The test status has the following groupings: Total Tests; Tests Not Started; In-Work; Tests Failed; and Completed Tests.

The Total Tests field includes the total number of test scripts that have been entered into the database for a given partner. The Tests Not Started field includes the total number of test scripts that do not have any test step with a pass or fail status. The In-Work status field includes the total number of test scripts that have at least one test step passed, excluding the last step. The Tests Failed field includes the total number of test scripts that have at least one test step failed. The Completed Tests field includes the total number of test scripts that have the last step passed, with no failed steps.

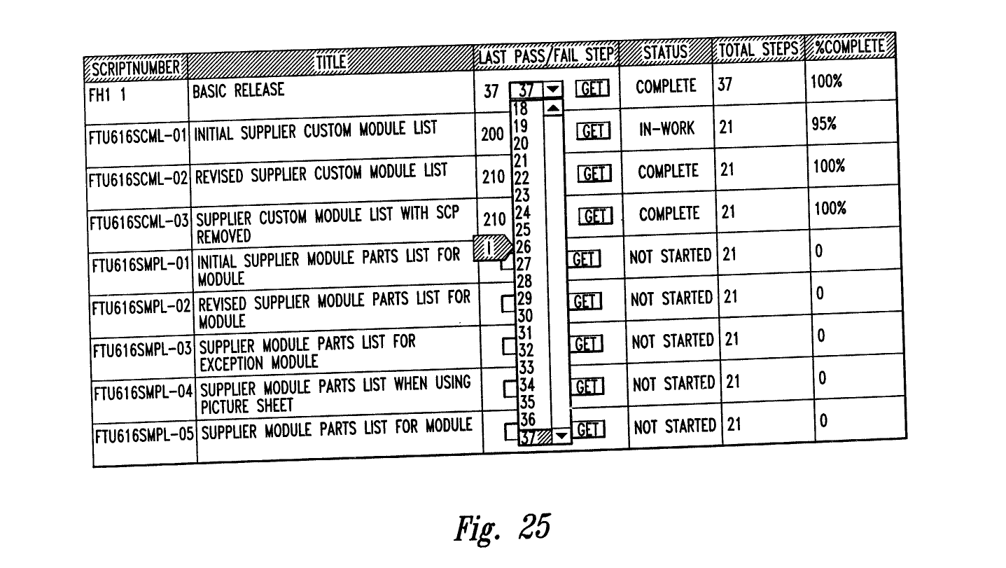

The Test Web Site, as shown in FIG. 25, provides the capability to view the detailed test status of an individual test script. The detailed test status has the following groupings: Test Number; Test Title; Last Step Pass/Fail; Test Status; Total Number of Steps; and Percent Complete. The Test Number column is the number assigned to the test script, the Test Title column is the title given to the test script, and the Last Step Pass/Fail column is the last test step number that has passed or failed. The user is displayed a drop down list of all test step numbers, in ascending order. The default test step number in the drop down list is the last test step that has passed or failed. The Test Status column displays the current test status of each test script, as discussed above. The Total Number of Steps column displays the total number to test steps for the test script. Finally, the Percent Complete column displays the percent of completed test steps for the test script (i.e. the number of completed test steps divided by the total number of test steps, represented in a whole number).

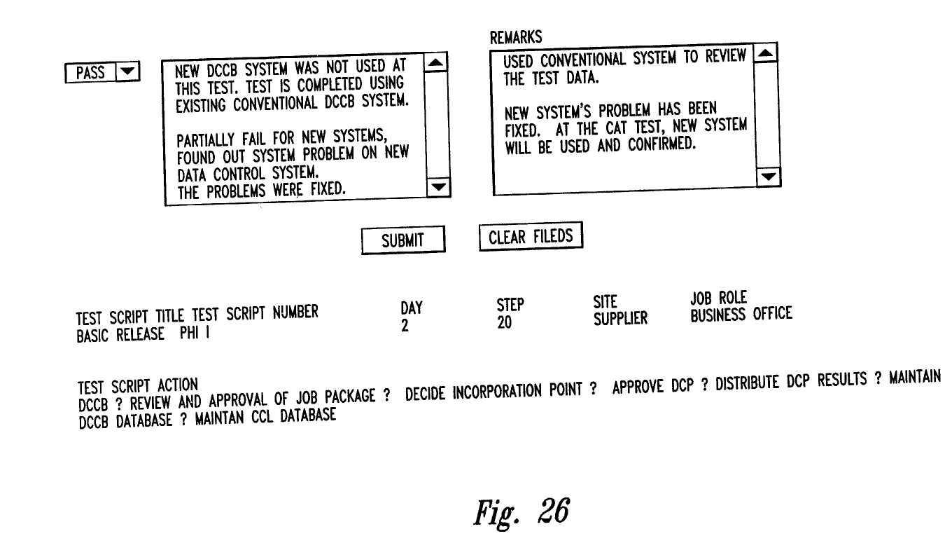

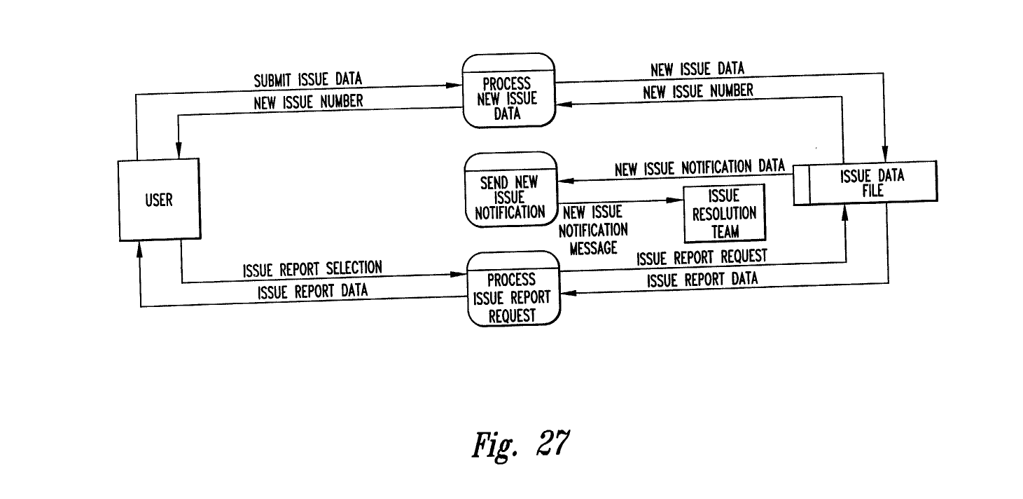

The Test Web Site, as shown in FIG. 26, provides the capability to enter test results of an individual test step. The test results are viewable by selecting the appropriate test step from the view detailed test status screen and selecting “get,” as discussed above. The enter test results screen has the following groupings: Pass/Fail; Results; Remarks; and all of the specific test step information.

The Pass/Fail column comprises a drop-down box containing the following three values: “blank”; Pass; and Fail. The user will be able to select only one of these selections. The Results column allows the user to enter any text he/she wishes, and the Remarks column allows the user to enter any text he/she wishes.

Once the user selects the “submit” button, the Pass/Fail, Results, and Remarks information is entered into the database. The user ID of the user doing this action and the date/time of this action is saved in the database. A provider or a partner user will be able to enter test results into any specific step. Once the user selects the “clear” button, the data entered into the Pass/Fail, Results, and Remarks fields is reset to the previous values.

As shown in FIG. 27, the Test Web Site 408 provides the capability to submit a new issue. The submit a new issue screen has the following fields: Title; Description; Problem Category; Problem Sub-Category; Test Phase; and Test Script. The Title field is a required entry field in which the user enters the title of the issue. The Description field is a required entry field in which the user enters a description of the issue. The Problem Category field consists of a drop-down list of the values listed in Table 2.

TABLE 2
List of Problem Categories
Problem Categories
TBD

The Problem Sub-Category field consists of a drop-down list of the values listed in Table 3.

TABLE 3
List of Problem Sub-Categories
Problem Sub-Categories
TBD

The Test Phase field consists of a drop-down list of the values listed in Table 4.

TABLE 4
List of Test Phases
Test Phases
DAISST
End-to-End

The Test Script field shall consists of a drop-down list of the titles of the Test Scripts, as listed in Table 5.

TABLE 5
List of Test Script Titles
List of Test Script Titles - DAISST

FTU616SCML-01 Process Initial Supplier Custom Module List
FTU616SCML-02 Process Revised Supplier Custom Module List
FTU616SCML-03 Process Supplier Custom Module List with SCP
Removed
FTU616SMPL-01 Process Initial Supplier Module Parts List for Module
FTU616SMPL-02 Process Revised Supplier Module Parts List for Module
FTU616SMPL-03 Process Supplier Module Parts List for Exception
Module
FTU616SMPL-04 Process Supplier Module Parts List when using Picture
Sheet Controlled Components or Installation Features
FTU616SMPL-05 Process Supplier Module Parts List for Module at
Developmental Phase

Once the user selects a “submit” button, the above entered/selected information shall be entered into the database 410, along with the user ID, and date/time. The Test Web Site assigns the submitted issue an issue number and display that number to the user.

The Test Web Site sends an email to a predetermined list of provider employees, indicating a new issue has been submitted. Refer to Table 6 for a list of people receiving a “new issue” email. It is envisioned that the people that receive this email are the appropriate people that need to start the issue resolution process. Another external source, outside of the Test Web Site, will be used to document issue resolution progress.

TABLE 6
List of People Receiving New Issue Email
People Receiving “New Issue” Email - DAISST

| Name | Email Address |
|---|---|
| Cindy | ‘cindy@boeing.com’ |
| Nancy | ‘nancy@boeing.com’ |
| Cole | ‘w.c.@boeing.com’ |
| TBD | |

If the issue was submitted by a partner, the email body includes a statement that indicates which partner company submitted the issue, the name of the individual who submitted the issue, the issue number, and the issue title.

If the issue was submitted by a provider user, the email body includes a statement that states that the issue was submitted on behalf of a partner, the name of the partner, the name of the individual who submitted the issue, the issue number, and the issue title.

The Test Web Site provides the capability to view issue reports. The user requests the following issue reports: View All Issues; View Proposed Issues; View Open Issues; View Closed Issues; and View an Individual Issue.

Upon selection of the View All Issues “Go” button, the Test Web Site 408 provides a list of all issues that that partner has in the database. Viewing all issues shall retrieve all issues, whether the issue has the issue indicator set as Yes or No

Upon selection of a View Proposed Issues “Go” button, the Test Web Site provides a list of all temporary issues that that partner has in the database. Viewing proposed issues shall retrieve only those issues that have the issue indicator set as No.

Upon selection of the View Open Issues “Go” button, the Test Web Site 408 provides a list of all open issues that the partner has in the database. Viewing open issues shall retrieve only those issues that have the issue indicator set as Yes, and there is no Closed Date, and there is no Pending Date.

Upon selection of the View Pending Issues “Go” button, the Test Web Site provides a list of all pending issues that that partner has in the database. Viewing pending issues shall retrieve only those issues that have the issue indicator set as Yes, and there is no Closed Date, and there is a Pending Date.

Upon selection of the View Closed Issues “Go” button, the Test Web Site 408 provides a list of all closed issues that that partner has in the database. Viewing closed issues shall retrieve only those issues that have a Closed Date.

The Test Web Site provides the capability for the user to enter an individual issue number and retrieve the latest status of that issue.

The partner will be able to view the following fields of information upon selection of one of the issue reports discussed above: Number; Title; Description; Start Date; Assign Date; Due Date; Pending Date; Slip Date; Closed Date; and Status.

The Number field contains the issue number, the Title field contains the title of the issue, and the Description field contains the description of the issue.

The Start Date field contains the date that the issue was received by the provider. This field is machine generated. The Assign Date field contains the date that a provider user first looked at the issue. The Due Date field originally contains a date that is ten days into the future from the Start Date. This field is originally machine generated, but can be manually updated via an external source to the database. The Pending Date field contains the estimated date of partner resolution. The Slip Date field contains a new Pending Date, if there is one. The Closed Date field contains a date that the partner and provider concur that the issue has been resolved. The Status field contains textual information that summarizes the progress of this issue's resolution. This field is manually entered via an external source to the database.

An Action Item Description field contains a description of an action item that was assigned pertaining to the resolution of the issue. There could be many action items that are assigned to resolve a particular issue. The Action Item Deliverable field contains a description of a deliverable(s) that are being used to resolve the issue. This field is manually entered via an external source to the database. The Action Item Due Date field contains a date when the action item is/was due. The Action Item Status field contains an indication of whether the action item is open or closed.

As shown in FIG. 21, the Test Web Site provides the capability to view Test Plans. Further, as shown in FIG. 21, the Test Web Site provides the capability to view Test Schedules. The Test Schedules are specific to a given partner. The Test Web Site stores the Test Schedules in a directory specific to a partner. Upon selection of “Test Schedule,” the Test Web Site checks which partner this user represents, and then displays the Test Schedule associated with this partner.

This embodiment allows a single source of testing data, interactive testing progress, reactive test status, integrated issues process, which increase efficiency and reduce cost for this collaborative effort.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

What is claimed is:

1. A method of reducing the overall time required for more than one party to collaboratively perform a number of tasks, where each task requires a series of collaborative actions, said method comprising the steps of:
recording the series of collaborative actions into a script of database;
displaying a status of the actions taken in each of the tasks, wherein the status of each task may be simultaneously viewed, and wherein each party may view the status of each task.

2. The method according to claim 1, wherein said step of recording into the script database includes:
ordering each of the actions into a series of sequential steps; and
assigning an individual, group, machine, or combination thereof of one party to perform each of the actions.

3. The method according to claim 2, wherein said step of recording into the script database further includes:
designating the dates that one or more actions will be performed; and
indicating the location where each of the actions is to be performed.

4. The method according to claim 1 wherein said step of recording includes inputting the script database into an electronic file.

5. The method according to claim 1 wherein said step of displaying the status of the tasks is performed by providing access to the status via the Internet.

6. The method according to claim 1 wherein said step of displaying the status of the tasks includes:
indicating two or more tasks and whether a part of one of the tasks has not started, is in work, or has been completed.

7. The method according to claim 1 wherein said step of displaying the status of the tasks further includes indicating the last action completed within each of the tasks that are in work.

8. The method according to claim 7 wherein said step of displaying the status of the tasks further includes:
displaying the total number of actions in each of the tasks; and
displaying the percentage of the number of actions completed for each of the tasks.

9. A method of testing the interactivity of computing systems of two or more parties, said method comprising the steps of:
electronically storing a test script for each test of the computing systems; and
transmitting a status of each of the tests to any of the parties.

10. The method of testing according to claim 9 wherein said step of electronically storing the test script includes:
inputting one or more actions to be performed to carry out the test; and
associating a sequential step with each of said one or more actions.

11. The method of testing according to claim 10 wherein said step of storing the test script further includes:
inputting an entity or computing device to perform a particular one of said actions for each of said one or more actions.

12. The method of testing according to claim 11 wherein said step of storing the test script further includes:
inputting a site where a particular one of said actions will be performed; and
inputting a day or range of days when a particular one of said actions will be performed.

13. The method of testing according to claim 9 wherein said step of transmitting the status of each of the tests includes:
transmitting an overall test status having a total number of tests to be performed between the parties;
number of the tests not yet started, a total number of the tests in work, and a total number of tests failed.

14. The method of testing according to claim 9 wherein said step of transmitting the status of each of the tests includes:
providing an identification of each test script to be performed between the parties and whether the particular test associated with each test script was either in work, not started, or was completed.

15. The method of testing according to claim 9 wherein said step of transmitting the status of each of the tests includes:
indicating the last action to have been completed for each test script.

16. The method of testing according to claim 15, wherein said step of transmitting the status of each of the tests further includes:
identifying whether the last action to have been completed failed or passed in the particular test script.

17. The method according to claim 15 wherein said step of transmitting includes:
providing the total actions required for each test; and
indicating a percentage of the actions that have been completed for each particular test.

18. A time management system for reducing the overall time required for more than one party to collaborate on a number of tasks, where each task requires a series of collaborative actions, said system comprising:
a script database;
means for recording the series of collaborative actions into said script database; and
means for displaying a status of the actions taken in each of the tasks to each party, wherein each party may view the status of each task.

19. The system according to claim 18 wherein the means for recording comprises:
means for ordering each of the actions into a series of sequential steps; and
means for assigning an individual, group, machine, or combination thereof, of one party to perform each of the actions.

20. The system according to claim 19 wherein said means for recording further comprises:
means for designating the date that one or more actions will be performed; and
means for indicating the location where each of the actions will be performed.

21. The system according to claim 18 wherein said displaying means comprises:
means for indicating the last action completed within each of the tasks that are in work.

22. The system according to claim 21 wherein said displaying means further comprises:
means for indicating the last action completed within each of the tasks that are in work.

23. The system according to claim 22 wherein said displaying means further comprises:
means for displaying the total number of actions in each of the tasks; and
means for displaying the percentage of the number of actions completed for each of the tasks.

24. A system for testing the interactivity of computing systems of two or more parties, said system comprising:
means for electronically storing a test script for each of the computing systems; and
means for transmitting a status of each of the tests to any of the parties.

25. The system according to claim 24 wherein said electronic storing means comprises:
means for inputting one or more actions to be performed to carry out the test; and
means for associating a sequential step with each of said one or more actions.

26. The system according to claim 25 wherein said electronic storing means further comprises:
inputting means for entering an entity or computing device to perform a particular one of said actions for each of said one or more actions.

27. The system according to claim 26 wherein said electronic storing means further comprises:
means for inputting a location where a particular action will be performed; and
means for inputting a day or range of days when a particular action will be performed.

28. The system according to claim 24 wherein said transmitting means comprises:
means for transmitting an overall test status including a total number of tests to be performed between the parties;
a number of the tests in work; and
a total number of tests failed.

29. The system according to claim 24 wherein said transmitting means comprises:
means for providing an identification of each test script to be performed between the parties and for determining whether the particular test associated with each test script was either in work, not started, or was completed.

30. The system according to claim 24 wherein said transmitting means comprises:
means for indicating the last action to have been completed for each test script.

31. The system according to claim 30 wherein said transmitting means further comprises:
means for identifying whether the last action to have been completed, failed or passed in the particular test script.

32. The system according to claim 30 wherein said transmitting means comprises:
means for providing the total actions required for each test; and
means for indicating the percentage of the actions that have been completed for each particular test.

33. A computer readable medium containing instructions for controlling a computer system to perform a method, the method comprising:
recording a plurality of tasks that are collaboratively performed between parties, wherein each of said tasks includes a series of actions;
recording the series of actions;
displaying a status of the actions taken in each of tasks;
providing immediate access to each party to allow viewing of the status of each task, thereby reducing the overall time required for the parties to perform the collaborative tasks.

34. The medium according to claim 33 wherein the step of recording the series of actions comprises:
ordering each of the actions into a series of sequential steps;
assigning an individual, group, machine, or combination thereof of one of the parties to perform each of the actions;
designating the date that one or more of the actions will be performed; and
indicating the location where each of the actions is to be performed.

35. The medium according to claim 33 wherein the step of displaying the status of the tasks comprises:
indicating two or more tasks and whether a particular one of the tasks is not started, is in work, or has been completed;
indicating the last action completed within each of the tasks that are in work;
displaying the total number of actions in each of the tasks; and
displaying the percentage of the number of actions completed for each of the tasks.

36. A memory for storing data for access by a process, which is used to assist in the testing of computing system of two or more parties, being executed by a processor, the memory comprising:
a test script used by each of the computing systems, said script including:
one or more actions to be performed by one of the parties to carry out the test;
a sequential step associated with each of said one or more actions;
a performer of a particular one of said actions for each of said one or more actions;
a location where a particular one of said actions will be performed; and
a range of days when a particular one of said actions will be performed; and
a status of each of the tests including:
a last action to have been completed for each test script;
indication of whether the last action to have been completed failed or passed in the particular test script;
total actions required for each test; and
percentage of the actions that have been completed for each particular test.
